(19) United States
(12) Patent Application Publication
(10) Pub. No.: US 2011/0318598 A1
(43) Pub. Date: Dec. 29, 2011

(54) JOINED METAL MEMBER, METAL JOINING METHOD AND METAL JOINING APPARATUS

(75) Inventors: Kazuhiro Murakami, Shizuoka (JP); Yoshihiko Watanabe, Shizuoka (JP); Kazuhide Takahashi, Shizuoka (JP); Kimitoshi Makino, Shizuoka (JP)

(73) Assignee: YAZAKI CORPORATION, Tokyo (JP)

(21) Appl. No.: 13/255,552

(22) PCT Filed: Mar. 10, 2010
(86) PCT No.: PCT/JP2010/054055

§ 371 Date: Sep. 9, 2011

(30) Foreign Application Priority Data
Mar. 10, 2009 (JP) 2009-056309

(51) Int. Cl. B32B 3/24; B32B 15/01; B21D 31/00

(52) U.S. Cl. 428/596; 72/379.2

(57) ABSTRACT

In a first metal plate 10 in which a first hole 16 is formed, a second metal plate 12 in which a second hole 18 is formed and a third metal plate 11 which is sandwiched between the first metal plate 10 and the second plate 12 and in which a third hole 17 is formed, a first protruding portion 13 is provided integrally with the first metal plate 10, and a second protruding portion 14 is provided integrally with the third metal plate 11. The first protruding portion 13 extends from part of an end face of the first metal plate 10 which defines the first hole 16 and is bent towards the third metal plate 11 so as to fit into the third hole 17. The second protruding portion 14 extends from part of an end face of the third metal plate 11 which defines the third hole 17 and is bent towards the second metal plate 12 so as to fit into the second hole 18. Metal joined portions 19 are formed in which the first protruding portion 13 and the end face of the third metal plate 11 which defines the third hole 17 are joined together and the second protruding portion 14 and the end face of the second metal plate 12 which defines the second hole 18 are joined together. The first metal plate 10, the second metal plate 12 and the third metal plate 11 are stacked one on another. The first protruding portion 13 has the same shape as that of the second protruding portion 14 and is stacked on the second protruding portion 12.

### TECHNICAL FIELD

The present invention relates to a joined metal member, a metal joining method and a metal joining apparatus and more particularly to a joined metal member in which three or more metal plates are joined together and a metal joining method and apparatus for joining three or more metal plates together.

### BACKGROUND ART

As a method for joining metal plates together, there is conventionally known a method for compression bonding metal plates together through crimping. However, in joining through crimping, since joining the metal plates together is dependent on residual stress and contact which result from crimping, sufficient electrical properties are not provided. In addition, there exist many gaps in the contact portions, leading to a problem that it is difficult to ensure the electrical properties over a long period of time from the viewpoint of corrosion. Additionally, although it is considered to melt metal plates by use of gas or plasma so as to weld them together with a view to ensuring the electrical properties, it is difficult to automate the process, and hence, the process is not suitable for mass production, leading to a cost problem.

### SUMMARY OF THE INVENTION

### Problem that the Invention is to Solve

Then, the invention provides a joined metal member in which three or more metal plates are joined together and a metal joining method and metal joining apparatus for joining three or more metal plates together to realize an increase in reliability.

### Means for Solving the Problem

A joined metal member of the invention has a first metal plate, a second metal plate, a third metal plate, a first protruding portion, a second protruding portion, a first metal joined portion and a second metal joined portion. The third metal plate is sandwiched between the first metal plate and the second metal plate. A first hole is formed in the first metal plate, a second hole is formed in the second metal plate, and a third hole is formed in the third metal plate. The first protruding portion is provided integrally with the first metal plate so that the first protruding portion extends from part of an end face of the first metal plate which defines the first hole to be bent towards the third metal plate so as to fit into the third hole. The second protruding portion is provided integrally with the third metal plate so that the second protruding portion extends from part of an end face of the third metal plate which defines the third hole to be bent towards the second metal plate so as to fit into the second hole. The first metal joined portion is a portion where the first protruding portion and the end face of the third metal plate which defines the third hole are jointed together. The second metal joined portion is a portion where the second protruding portion and the end face of the second metal plate which defines the second hole are joined together. The first metal plate, the second metal plate and the third metal plate are stacked one on another. The first protruding portion has the same shape as that of the second protruding portion. The first protruding portion and the second protruding portion are stacked one on the other.

At least two of the first metal plate, the second metal plate and the third metal plate may be made of metals which are different in kind from each other.

At least one of the first metal plate, the second metal plate and the third metal plate may be plated.

Thicknesses of at least two of the first metal plate, the second metal plate and the third metal plates may be different from each other.

A width of the first protruding portion in a direction which intersects the extending direction thereof at right angles may be increased as the first protruding portion extends in its extending direction, and a width of the second protruding portion in a direction which is at right angles to the extending direction thereof may be increased as the second protruding portion extends in its extending direction.

A fourth hole may be formed in the first metal plate, and the third protruding portion may extend from part of an end face of the first metal plate which defines the fourth hole. The first protruding portion and the third protruding portion are made to extend from a portion between the first hole and the fourth hole.

A metal joining method of the invention includes a step of stacking a first metal plate including a first portion, a second metal plate including a second portion having the same shape as that of the first portion and a third metal plate including a third portion having the same shape as that of the second portion one on another so that the third metal plate is disposed between the first metal plate and the second metal plate and that the first portion, the second portion and the third portion are superposed one on another, a step of pressing the first portion of the first metal plate in such a way that part of an outer circumference of the first portion is cut so as to cause the first portion to be bent towards the third metal plate, that part of an outer circumference of the third portion is cut so as to cause the third portion to be bent towards the second metal plate, and that part of an outer circumference of the second portion is cut so as to cause the second portion to be bent to an opposite side to the second metal plate so that the first portion is brought into contact with a non-cut surface of the third metal plate and the third portion is brought into contact with a non-cut surface of the second metal plate.

A metal joining apparatus of the invention has a first die and a second die. The first die has a press projection for pressing a metal plate in which a height in a pressing direction at a first end of a first direction which intersects the pressing direction at right angles is higher than a height in the pressing direction at a second end which is opposite to the first end in the first direction. A press hole having a shape which corresponds to that of the press projection is formed in the second die.

A length of the first end in a second direction which intersects the pressing direction and the first direction at right angles may be longer than a length of the second end in the second direction.

The first die may have a second press projection. A second press hole having a shape which corresponds to that of the second press projection is formed in the second die. A height in the pressing direction of the second press projection at a first end in the first direction is higher than a height in the pressing direction of the second press projection at a second end in the first direction, and the second end of the press projection and the second end of the second press projection are disposed between the first end of the press projection and the first end of the second press projection.

### Advantage of the Invention

As has been described heretofore, according to inventions described in Claims 1, 7 and 8, since friction is generated between cut outer circumferential surfaces of the protruding portion of the metal plates and cut inner circumferential surfaces of the holes in the metal plates which are stacked directly one on another in the pressing direction when the metal plates are pressed so that the metal joined portions are obtained, the increase in electrical properties and reliability can be realized.

According to an invention described in Claim 1, the metal plates which are made of different kinds of metals can be joined together.

According to an invention described in Claim 3, since the metal plates can be softened by plating at least one of the metal plates, the metal plates can be cut easily by exerting thereon a force exceeding the yield stress of the metal plates.

According to an invention described in Claim 4, the metal plates having different thickness can also be joined together.

According to an invention described in Claim 5, since the joining of the metal joined portions is promoted by a normal load generated in the cut surfaces by the protruding portions being pressed into the holes towards the sides thereof where the widths of the holes are reduced, a further increase in electrical properties and reliability can be realized.

According to an invention described in Claim 6, two metal joined portions can be obtained across one non-cutting line, thereby making it possible to realize a further increase in electrical properties and reliability.

### BRIEF DESCRIPTION OF THE DRAWINGS

FIG. 1 A partial perspective view of a joined metal member of the invention.

FIG. 2 A top view of the joined metal member shown in FIG. 1.

FIG. 3 A view of the joined metal member shown in FIG. 2 when it is seen in a direction indicated by an arrow P1.

FIG. 4 A view of the joined metal member shown in FIG. 2 when it is seen in a direction indicated by an arrow P2.

FIG. 5 A sectional view of the joined metal member shown in FIG. 2 which is taken along the line I-I.

FIG. 6 A sectional view of the joined metal member shown in FIG. 2 which is taken along the line II-II.

FIG. 7 A drawing showing a metal joined portion shown in FIG. 6.

FIG. 8 A perspective view showing one embodiment of a metal joining apparatus of the invention.

FIG. 9 A top view of a first die which makes up the metal joining apparatus shown in FIG. 8.

FIG. 10 A sectional view of the metal joining apparatus shown in FIG. 8 which is taken along the line III-III, showing a state before the joined metal member is pressed.

FIG. 11 A sectional view of the metal joining apparatus shown in FIG. 8 which is taken along the line III-III, showing a state after the joined metal member has been pressed.

### MODE FOR CARRYING OUT THE INVENTION

Hereinafter, an embodiment of the invention will be described based on the drawings.

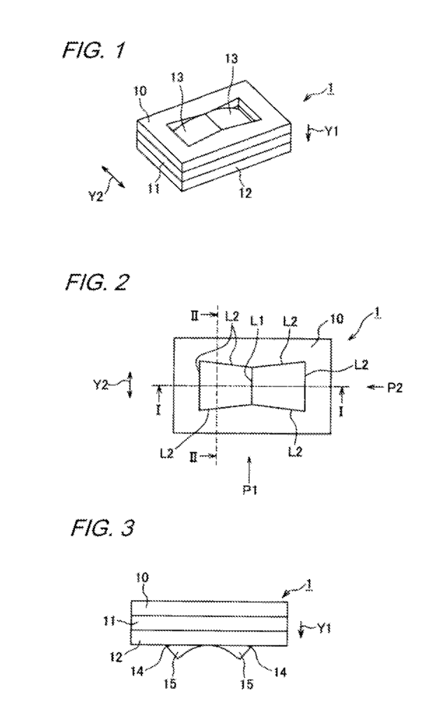

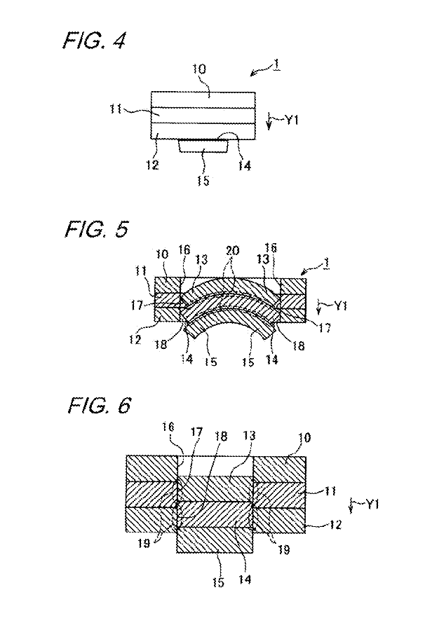

As is shown in FIGS. 1 to 7, a joined metal member 1 includes three metal plates 10, 11, 12 which are made of the same metal, for example. As is shown in FIG. 5, the joined metal member 1 includes protruding portions 13, 14, 15, holes 16, 17, 18 and metal joined portions 19 (FIG. 6).

The protruding portion 13 is provided in the metal plate 10. The protruding portion 14 is provided in the metal plate 11. The protruding portion 15 is provided in the metal plate 12. The protruding portions 13 to 15 are, as is shown in FIG. 2, provided so as to project in a pressing direction Y1 by cutting the three metal plates 10 to 12 along cutting lines L2 which each extend from one end of a non-cutting line L1 to the other end of the non-cutting line L1 by way of a side which lies away from the non-cutting line L1 and simultaneously pressing portions of the two metal plates 10, 11 which are surrounded by the cutting lines L2 and the non-cutting line L1 in such a state that the three metal plates 10 to 12 are superposed one on another. In this embodiment, two cutting lines L2 are provided for one non-cutting line L1 so as to face each other across the non-cutting line 1.

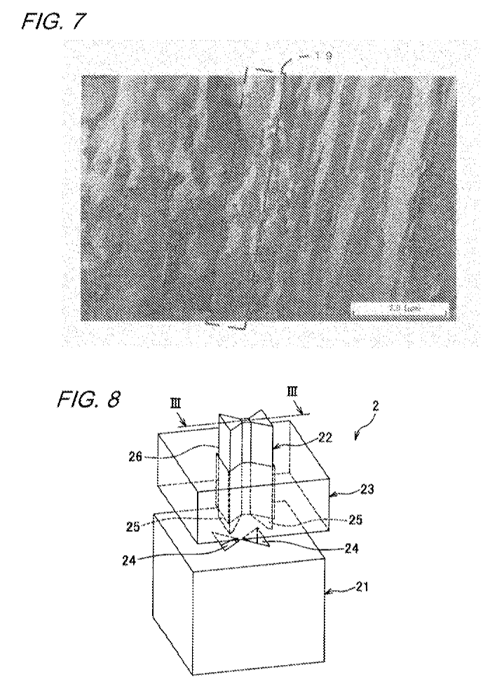

The hole 16 is formed by providing the protruding portion 13 in the metal plate 10. The hole 17 is formed by providing the protruding portion 14 in the metal plate 11. The hole 18 is formed by providing the protruding portion 15 in the metal plate 12. The protruding portions 13, 14 of the remaining metal plates 10, 11 excluding the metal plate 12 which lies most forwards in the pressing direction Y1 are forced into the holes 17, 18 in the metal plates 10, 11 which are superposed directly one on the other in the pressing direction Y1. As this occurs, the protruding portion 13 is forced into the hole 17 with a cut outer circumferential surface thereof caused to rub against a cut inner circumferential surface of the hole 17, and the protruding portion 14 is forced into the hole 18 with a cut outer circumferential surface thereof caused to rub against a cut inner circumferential surface of the hole 18. Because of this, oxide layers are removed by friction so that fresh surfaces are exposed, whereby the cut outer circumferential surfaces of the protruding portions 13, 14 adhere to the cut inner circumferential surfaces of the holes 17, 18, and as is shown in FIGS. 6 and 7, metal joined portions 19 are obtained. It is seen from FIG. 7 that the metals are joined together with no gaps provided therebetween. In addition, the shapes of the protruding portions 13 to 15 are deformed by being pressed. Friction is also generated by the deformation in a portion where the protruding portions 13, 14 are superposed one on the other and a portion where the protruding portions 14, 15 are superposed one on the other, whereby metal joined portions 20 (FIG. 5) are obtained. Thus, an increase in electric resistance and joining strength can be realized by integration of the metals.

According to the joined metal member 1 described above, since friction is generated between the cut outer circumferential surfaces of the protruding portions 13, 14 of the metal plates 10, 11 and the cut inner circumferential surfaces of the holes 17, 18 in the metal plates 11, 12 which are disposed adjacent to each other in the pressing direction Y1 when the metal plates 10, 11, 12 are pressed so as to obtain the metal joined portions 19, an increase in electrical properties and reliability can be realized.

In addition, according to the joined metal member 1 described above, since the three metal plates 10 to 12 can be joined together in a general pressing process, the necessity of special equipment to obtain metallic bond is obviated, thereby making it possible to avoid an increase in parts cost.

As is shown in FIG. 2, the cutting line 2 is provided so that widths of the protruding portions 13 to 15 and the holes 16 to 18 in a non-cutting line direction Y2 are reduced as the cutting line L2 approaches the non-cutting line L1.

Namely, a portion surrounded by the non-cutting line L1 and the cutting line L2 is formed into a trapezoidal shape with the non-cutting line L1 functioning as an upper side.

In this configuration, when the protruding portions 13, 14 are pressed downwards, the protruding portions 13, 14 are forced individually into narrower portions in width of the holes 17, 18, whereby a normal load is generated in the cut outer circumferential surfaces of the protruding portions 13, 14 and the cut inner circumferential surfaces of the holes 17, 18. As this occurs, the joining of the metal plates 10 to 12 is promoted, and an increase in joining strength of the metal joined portions 19 can be realized.

According to the joined metal member 1 described above, the two cutting lines L2 are provided for the non-cutting line L1 so as to face each other across the non-cutting line L1. By so providing the cutting lines L2, the two metal joined portions 19 can be obtained on either side of the non-cutting line L1, thereby making it possible to realize a further in crease in electrical properties and reliability.

Next, a metal joining apparatus 2 for joining together the three metal plates 10 to 12 described above will be described below by reference to FIGS. 8, 10 and 11.

As is shown in those figures, the metal joining apparatus 2 is made up of a first die 22, a second die 21 and a guide 23.

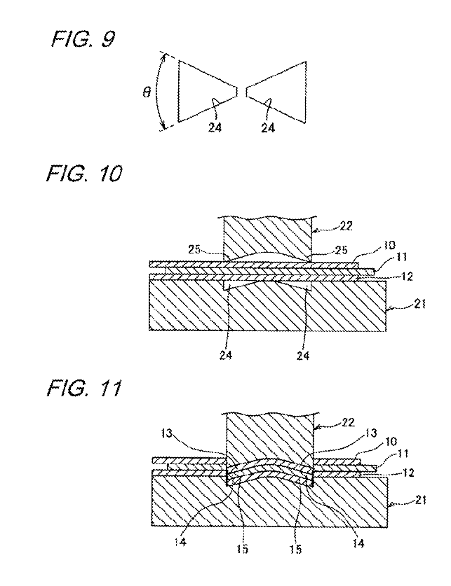

The second die 21 is provided into a rectangular parallelepiped shape, for example, and includes tow press holes 24 in an upper surface thereof. Each of the press holes 24 is provided into a trapezoidal shape which is identical to the shape of the portion surrounded by the non-cutting line L1 and the cutting line L2 in the metal plates 10 to 12 and is made to get shallower in depth as the hole 24 approaches the non-cutting line L1. A depth of a portion of the press hole 24 which corresponds to the non-cutting line L1 is 0 or is such that the non-cutting lines L1 of the metal plates 10 to 12 are not cut. In the event that a total plate thickness of metal plates which are wanted to be joined together is increased, a divergence θ (FIG. 9) of each of the two press holes 24 needs to be increased. In the event that this divergence θ is larger than 15°, normal stress can be applied which is sufficient to cut altogether three or more metal plates by the second die 21 and the first die 22, which will be described later.

The first die 22 is provided into a rod-like shape. A shape of the first die 22 which results when it is seen from thereabove is formed into a ribbon-like shape which is formed by joining together shorter parallel sides of two trapezoids. Two press projections 25 are provided at a distal end of the first die 22 in the pressing direction Y. The two press projections 25 are formed into a shape which enables them to fit individually into the two press holes 24. The two press projections 25 are also provided so that their projecting height in the pressing direction Y is reduced as the press projections 25 approach the non-cutting line L1.

The guide 23 is provided into a rectangular parallelepiped shaped, for example, and a guide hole 26 is provided in the guide 23 which penetrates therethrough in the pressing direction Y1. The guide hole 26 is provided into a ribbon-like shape which enables the first die 22 to fit thereinto so as to guide the first die 22 in the pressing direction Y1.

Next, a metal joining method will be described which employs the metal joining apparatus 2 described above. Firstly, as is shown in FIG. 10, the three metal plates 10 to 12 are stacked one on another and are then placed on the second die 21.

Thereafter, as is shown in FIG. 11, the first die 22 is caused to move along the guide hole 26 in the guide 23 in the pressing direction Y1, and the metal plates 10 to 12 are sandwiched between the second die 21 and the first die 22.

When the first die 22 is caused to move further in the pressing direction Y1, the metal plates 10 to 12 are cut along the cutting lines L2 by edges of the press projections 25 along the cutting lines L2 and edges of the press holes 24 along the cutting lines L2. Simultaneously, the portions of the metal plates 10 to 12 which are surrounded by the cutting lines L2 and the non-cutting line L1 are pressed in the pressing direction, whereby the protruding portion 13 of the metal plate 10 is forced into the hole 17 in the metal plate 11, and the protruding portion 14 of the metal plate 11 are forced into the hole 18 in the metal plate 12, and the cut outer circumferential surfaces of the protruding portions 13, 14 adhere to the cut inner circumferential surfaces of the holes 17, 18, whereby the metal joined portions 19 are obtained.

According to the metal joining apparatus 2 described above, since the metal plates 10 to 12 can be joined together though a general pressing process, special equipment to obtain metallic bond is unnecessary, thereby making it possible to avoid an increase in parts cost.

According to the embodiment that has been described heretofore, while the joined metal member 1 is provided by joining together the three metal plates 10 to 12, the invention is not limited thereto. The joined metal member 1 may be provided by joining together three or more metal plates.

According to the embodiment that has been described heretofore, while in the joined metal member 1 the three metal plates 10 to 12 are joined together which are made of the same metal, the invention is not limited thereto. It has been verified that metal joint can be obtained among different metals such as tin, zinc, gold and silver, provided that three or more metal plates can be pressed to be cut. Namely, at least two of three or more metal plates may be made of metals which are different from each other.

In addition, at least one of three or more metal plates may be plated with tin, zinc, gold or silver. Since the metal plates can be softened by plating at least one of the metal plates in the way described above, the metal plates can easily be cut by exerting thereon a force exceeding the yield stress of the metal plates.

According to the embodiment that has been described above, while in the joined metal member 1 the metal plates 10 to 12 whose thicknesses are identical to each other are joined together, the invention is not limited thereto. It has been verified that metal joint can be obtained among metal plates which have different thicknesses, provided that three or more metal plates can be pressed to be cut. Namely, at least two of three or more metal plates may differ in thickness from each other.

According to the embodiment that has been described above, while the cutting lines L2 are provided so that the widths in the non-cutting line direction Y2 of the protruding portions 13 to 15 and the holes 16 to 18 are reduced as they approach the non-cutting line L1, the invention is not limited thereto. The cutting lines L2 may be provided so that the widths in the non-cutting line direction Y2 of the protruding portions 13 to 15 and the holes 16 to 18 remain constant, for example.

According to the embodiment described above, while the two cutting lines L2 are provided for the one non-cutting line L1 so as to face each other across the non-cutting line L1, the invention is not limited thereto. For example, one cutting line L2 may be provided for one non-cutting line L1.

According to the embodiment described above, while the metal plates 10 to 12 are simply cut and pressed, for example, interdiffusion between the metal plates 10 to 12 may be aimed at by applying heat thereto at the same time as the metal plates 10 to 12 are cut and pressed or thereafter. By adopting this process, the range of metallic joint is expanded to as to attain a strong and rigid joint.

The embodiment is described only to illustrate a representative embodiment of the invention, and hence, the invention is not limited thereto. Namely, the embodiment can be carried out by being modified variously without departing from the gist of the invention.

### DESCRIPTION OF REFERENCE NUMERALS

2 metal joining apparatus; 10 metal plate; 11 metal plate; 12 metal plate; 13 protruding portion; 14 protruding portion; 15 protruding portion; 16 hole; 17 hole; 18 hole; 19 metal joined portion; 21 second die; 22 first die; 24 press hole; 25 press projection; L1 non-cutting line; L2 cutting line; Y1 pressing direction; Y2 non-cutting line direction.

1. A joined metal member comprising:
a first metal plate in which a first hole is formed;
a second metal plate in which a second hole is formed;
a third metal plate which is sandwiched between the first metal plate and the second metal plate and in which a third hole is formed;
a first protruding portion which is provided integrally with the first metal plate so that the first protruding portion extends from part of an end face of the first metal plate which defines the first hole to be bent towards the third metal plate so as to fit into the third hole;
a second protruding portion which is provided integrally with the third metal plate so that the second protruding portion extends from part of an end face of the third metal plate which defines the third hole to be bent towards the second metal plate so as to fit into the second hole;
a first metal joined portion where the first protruding portion and the end face of the third metal plate which defines the third hole are joined together; and
a second metal joined portion where the second protruding portion and the end face of the second metal plate which defines the second hole are joined together, wherein
the first metal plate, the second metal plate and the third metal plate are stacked one on another, wherein
the first protruding portion and the second protruding portion have the same shape, and wherein
the first protruding portion is stacked on the second protruding portion.

2. A joined metal member as set forth in claim 1, wherein
at least two of the first metal plate, the second plate and the third plate are made of metals which are different from each other.

3. A joined metal member as set forth in claim 1, wherein
at least one of the first metal plate, the second metal plate and the third metal plate is plated.

4. A joined metal member as set forth in claim 1, wherein
at least two of the first metal plate, the second metal plate and the third metal plate have thicknesses which are different from each other.

5. A joined metal member as set forth in claim 1, wherein
a width of the first protruding portion in a direction which intersects the extending direction thereof is increased as the first protruding portion extends in its extending direction, and wherein
a width of the second protruding portion in a direction which is at right angles to the extending direction thereof is increased as the second protruding portion extends in its extending direction.

6. A joined metal member as set forth in claim 1, wherein
a fourth hole is formed in the first metal plate, wherein
a third protruding portion is caused to extend from part of the end face of the first metal plate which defines the fourth hole, and wherein
the first protruding portion and the third protruding portion are caused to extend from a portion between the first hole and the fourth hole.

7. A metal joining method comprising:
stacking a first metal plate including a first portion, a second metal plate including a second portion having the same shape as that of the first portion and a third metal plate including a third portion having the same shape as that of the second portion so that the third metal plate is disposed between the first metal plate and the second metal plate and that the first portion, the second portion and the third portion are superposed one on another; and
pressing the first metal plate, the second metal plate and the third metal plate so that part of an outer circumference of the first portion of the first metal plate is cut to cause the first portion to be bent towards the third metal plate, that part of an outer circumference of the third portion is cut to cause the third portion to be bent towards the second metal plate, that part of an outer circumference of the second portion is cut to cause the second portion to be bent towards an opposite side to the second metal plate, that the first portion is brought into contact with a cut surface of the third metal plate and that the third portion is brought into contact with a cut surface of the second metal plate.

8. A metal joining apparatus comprising:
a first die having a press projection for pressing a metal plate in which a height in a pressing direction at a first end of a first direction which intersects the pressing direction at right angles is higher than a height in the pressing direction at a second end which is opposite to the first end in the first direction; and
a second die in which a press hole is formed which has a shape which corresponds to that of the press projection.

9. A metal joining apparatus as set forth in claim 8, wherein
a length of the first end in a second direction which intersects the pressing direction and the first direction at right angles is longer than a length of the second end in the second direction.

10. A metal joining apparatus as set forth in claim 8, wherein
the first die has a second press projection, wherein
the second die has a second press hole formed therein which has a shape which corresponds to that of the second press projection, wherein
a height in the pressing direction of the second press projection at a first end in the first direction is higher than a height in the pressing direction of the second press projection at a second end in the first direction, and wherein
the second end of the press projection and the second end of the second press projection are disposed between the first end of the press projection and the first end of the second press projection.
